(19) United States
(12) Patent Application Publication
(10) Pub. No.: US 2024/0390124 A1
(43) Pub. Date: Nov. 28, 2024

(54) DISPOSABLE DENTAL VACUUM LINE CLEANING DEVICE

(71) Applicant: Stoma Ventures, LLC, Chesterfield, MO (US)

(72) Inventor: Charles McCary, Huntsville, AL (US)

(21) Appl. No.: 18/665,886

(22) Filed: May 16, 2024

Related U.S. Application Data
(60) Provisional application No. 63/468,060, filed on May 22, 2023.

(51) Int. Cl. A61C 19/00; A61C 17/06; B08B 9/032

(52) U.S. Cl. CPC A61C 19/002; A61C 17/06; B08B 9/032; B08B 2209/032

(57) ABSTRACT

A disposable dental vacuum line cleaning device has a first section having a fluid input end that is adapted to be connected to a source of water, a tapered section, a straight section, and a first hemispherical section, and a second section having an output end that is adapted to mate with a valve, a straight section, an intermediate section, a second hemispherical section having a peripheral edge that is larger than the first hemispherical section so that the first hemispherical section is captured within the second hemispherical section, and a chemical positioned within the first section and the second section.

### RELATED APPLICATION

This application claims priority to U.S. Provisional Patent Application Ser. No. 63/468,060, filed on May 22, 2023, the disclosure of which is incorporated herein by reference.

### BACKGROUND

This disclosure relates to a disposable device for sanitizing a dental vacuum line and more particularly to a disposable dental vacuum line cleaning device for sanitizing a dental vacuum line of substances such as saliva, debris, and other fluids that are suctioned from a mouth of a patient during a dental procedure.

During a dental procedure it is important to be able to remove saliva, blood, water, tooth fragments, metals, and other debris or fluids from the mouth of a patient. Removal of this matter allows a dentist to be able to perform a procedure in an unobstructed manner. Various systems or devices have been developed to remove liquid and solid materials from a mouth during a dental procedure. One device that is capable of removing saliva is known as a saliva ejector or a low volume ejector. A saliva ejector typically comprises a plastic flexible tube for placement in the mouth of a patient. The saliva ejector tube is connected to a valve which in turn is connected via suction tubing to a source of vacuum. In this manner, saliva is passed through the ejector tube, the valve, and the tubing to be disposed of in a sanitary manner. Once the procedure is completed, the ejector should be discarded and the valve should be sterilized by autoclave to be used again. Although it is suggested to autoclave the valve after each use, it is known that the autoclave procedure is hardly ever done. Another device that is capable of removing solid materials is a high volume evacuator system. A high volume evacuator system generally consists of a tube that may be inserted into a mouth of a patient with the tube connected to a valve which is connected via a tubing to a source of vacuum. Again, in this manner, debris may be removed from the mouth of the patient. After the dental procedure, the tube is disposed of and the valve should be sterilized for reuse. However, although it is suggested to sterilize the valve after use, it is known that this suggested procedure is hardly ever followed.

As can be appreciated, the liquids and debris from a mouth of a patient that are removed by use of the saliva ejector or the high volume evacuator contaminate the vacuum lines. In view of this, it is beneficial to clean the vacuum lines on a periodic basis. For example, a dental office will use a line cleaner or chemical that is placed in a bucket or other container that flows through the saliva ejector or the high volume evacuator. The vacuum system suctions the line cleaner from the bucket, the saliva ejector or the high volume evacuator, and the vacuum hose, line, or tubing to a discharge point. However, there are problems associated with this method of cleaning or sanitizing dental vacuum lines. One problem is that potentially harmful chemicals have to be stored and used by dental personnel. Another problem is that the sanitizing process can require dental personnel to monitor the cleaning process which takes time that the dental personnel could be devoting to other activities or duties within the dental office. A further problem is that the chemicals can deteriorate or erode components associated with the saliva ejector or the high volume evacuator which leads to premature replacement of these devices.

Therefore, it would be desirable to have a disposable dental vacuum line cleaning device that reduces the effort and time required to currently sanitize dental vacuum lines. It would also be desirable to have a disposable dental vacuum line cleaning device that is easy to install on or remove from a dental valve attached to suction tubing connected to a source of vacuum. Further, it would be advantageous to have a disposable dental vacuum line cleaning device that does not require the storage or handling of hazardous chemicals.

### BRIEF SUMMARY

In one form of the present disclosure, a disposable dental vacuum line cleaning device comprises a first section having a fluid input end that is adapted to be connected to a source of water, a tapered section, a straight section, and a first hemispherical section, a second section having an output end that is adapted to mate with a valve, a straight section, an intermediate section, a second hemispherical section having a peripheral edge that is larger than the first hemispherical section so that the first hemispherical section is captured within the second hemispherical section and a chemical positioned within the first section and the second section.

In another form of the present disclosure, a disposable dental vacuum line cleaning device comprises a first section having a fluid input end that is adapted to be connected to a source of water, a tapered section, a straight section, a first hemispherical section having a first peripheral edge, a second section having an output end that is adapted to mate with a valve, a straight section, an intermediate section, a second hemispherical section having a second peripheral edge that is larger than the first peripheral edge so that the first hemispherical section is captured within the second hemispherical section, a lumen formed within the first section and the second section between the input end and the output end, and a chemical positioned within the lumen.

The present disclosure provides a disposable dental vacuum line cleaning device for use with a dental instrument that is suitable for one time use and may be discarded after a single use.

The present disclosure provides a disposable dental vacuum line cleaning device that is easy to install on a dental valve connected to suction tubing which is in turn connected to a source of vacuum.

The present disclosure provides a disposable dental vacuum line cleaning device that is small, lightweight, easy to handle, easy to install, and easy to operate.

The present disclosure also provides a disposable dental vacuum line cleaning device which is of simple construction and design and which can be easily employed with highly reliable results.

The present disclosure is related to a disposable dental vacuum line cleaning device that is capable of cleaning vacuum lines.

The present disclosure provides a disposable dental vacuum line cleaning device that may have an antimicrobial agent or chemical incorporated into the device to prevent any bacterial growth on the device. The antimicrobial agent or chemical may also be a coating applied to the disposable dental vacuum line cleaning device.

The present disclosure is related to a disposable dental vacuum line cleaning device that may be constructed of plastic that is recyclable or biodegradable to reduce the cost of the device and to allow the device to be disposable and discarded after a single use.

The present disclosure provides a disposable dental vacuum line cleaning device that includes a chemical that automatically removes and sanitizes any saliva, liquid, or other material produced during a dental procedure that is resident within a vacuum line.

The present disclosure provides a disposable dental vacuum line cleaning device that may be used with a dental valve and does not require that the valve be retrofitted.

The present disclosure provides a disposable dental vacuum line cleaning device that is easy to install on a dental valve connected to vacuum tubing which is in turn connected to a source of vacuum and has another end that may be connected to a source of water.

These and other advantages of the present disclosure will become apparent after considering the following detailed specification in conjunction with the accompanying drawings, wherein:

### BRIEF DESCRIPTION OF THE DRAWINGS

FIG. 1 is a perspective view of a disposable dental vacuum line cleaning device constructed according to the present disclosure;

FIG. 2 is a cross-sectional view of the disposable dental vacuum line cleaning device shown in FIG. 1 taken along the plane of line 2-2;

FIG. 3 is a cross-sectional view of the disposable dental vacuum line cleaning device shown in FIG. 1 taken along the plane of line 3-3;

FIG. 4 is an enlarged cross-sectional view of the disposable dental vacuum line cleaning device shown in FIG. 3 taken along the section of circle 4; and

FIG. 5 is an enlarged cross-sectional view of the disposable dental vacuum line cleaning device shown in FIG. 2 taken along the section of circle 5;

FIG. 6 is a cross-sectional view of another embodiment of a disposable dental vacuum line cleaning device constructed according to the present disclosure;

FIG. 7 is a cross-sectional view of another embodiment of a disposable dental vacuum line cleaning device constructed according to the present disclosure; and

FIG. 8 is a cross-sectional view of another embodiment of a disposable dental vacuum line cleaning device constructed according to the present disclosure.

### DETAILED DESCRIPTION OF A PREFERRED EMBODIMENT

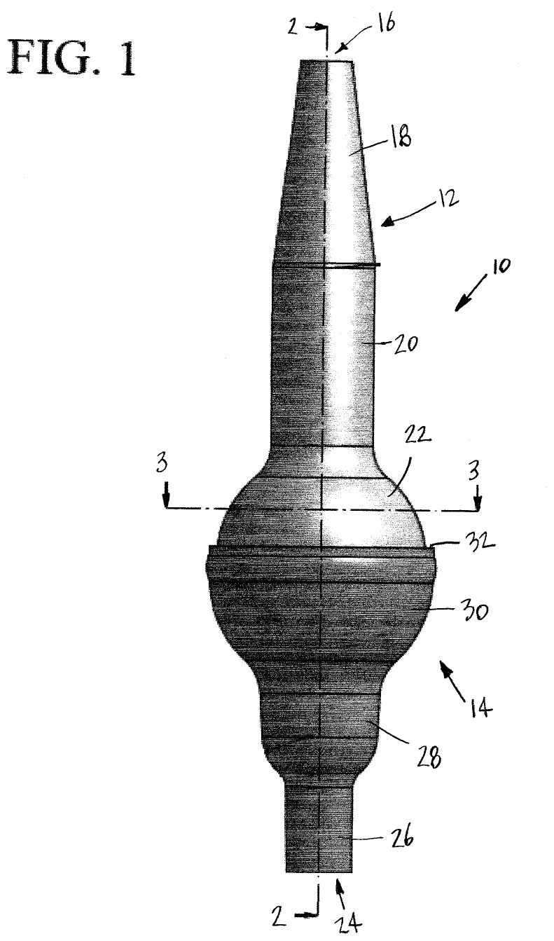

Referring now to the drawings, wherein like numbers refer to like items, number 10 identifies a disposable dental vacuum line cleaning device for use with a dental system (not shown) constructed according to the present disclosure. With reference now to FIG. 1, the device 10 comprises a first section 12 connected to a second section 14. The first section 12 has a water or fluid input end 16 that is adapted to be connected to a source of water (not shown), as will be explained in detail herein. The first section 12 has the input end 16, a tapered section 18, a straight section 20, and a first hemispherical section 22. The second section 14 has an output end 24 that is adapted to mate with a saliva ejector valve or a high volume evacuator, both of which are not shown. As can be appreciated, the valve or evacuator may be connected to a tailpiece which is connected to a vacuum line or tubing. The second section 14 has the output end 24, a straight section 26, an intermediate section 28, and a second hemispherical section 30. The second hemispherical section 30 has a peripheral edge 32 that is larger than the first hemispherical section 22 so that the first hemispherical section 22 is captured within the second hemispherical section 30. In this manner the first section 12 and the second section 14 may be secured together. The device 10 is constructed of material that allows the device 10 to be disposable and suitable for one time use. Although not shown in this particular view, within the device 10, as between the hemispherical sections 22 and 30, there may be stored or positioned a chemical that may flow through the output end 24 to clean or sanitize vacuum hosing or tubing. A source of water may be connected to the input end 16 so that water flows through the device 10 to interact with the chemical. The chemical is used to clean, sanitize, disinfect, or deodorize the vacuum hosing or tubing.

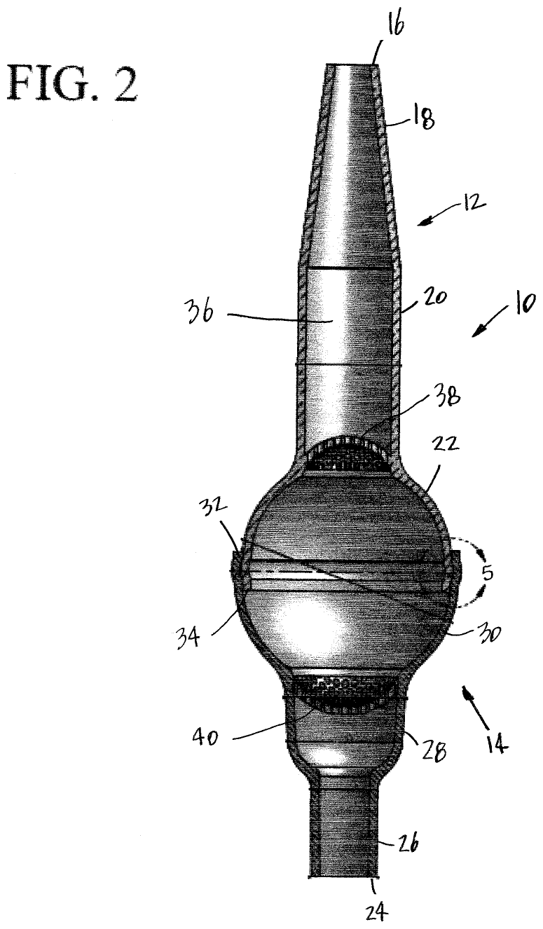

With reference now to FIG. 2, a cross-sectional view of the disposable dental vacuum line cleaning device 10 is illustrated. The device 10 comprises the first section 12 connected to a second section 14. The first section 12 has the input end 16, the tapered section 18, the straight section 20, and the first hemispherical section 22. The second section has the output end 24, the straight section 26, the intermediate section 28, and the second hemispherical section 30. The first hemispherical section 22 has a peripheral edge 34 that is smaller that the second hemispherical section 30 so that the first hemispherical section 22 fits within the second hemispherical section 30. A lumen 36 runs through the device 10 between the input end 16 and the output end 24. A first screen 38 is formed within the straight section 20 of the first section 12. A second screen 40 is formed within the intermediate section 28 of the second section 14. The hemispherical sections 22 and 30 and the screens 38 and 40 are used to capture and hold a chemical (not shown) that is used to sanitize vacuum line hosing or tubing. Water or fluid entering from the input end 16 may flow through the lumen 36 through the first screen 38, the hemispherical sections 22 and 30, the second screen 40 and out through the output end 24. The first section 12 and the second section 14 may be constructed of a translucent material so that it can be determined when the chemical has been used up or spent which indicates that the vacuum line has been sanitized. It is also possible that the chemical may include a dye so that when the dye is gone the water supply may be shut off and the device 10 may be removed from the vacuum line.

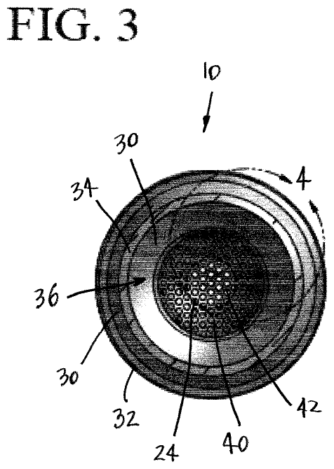

FIG. 3 depicts a cross-sectional view of the interior of the device 10 looking at the second screen 40 toward the output end 24. The device 10 is shown having the second peripheral edge 32 surrounding the first peripheral edge 34. A portion of the second hemispherical section 30 is also visible. The second screen 40 is also shown in the lumen 36. The second screen 40 has a number of openings or holes 42 through which water and chemicals can flow. It is contemplated that the chemical may take on various forms such as a powder, gel, liquid, tablet, or a combination thereof. One example of a chemical that may be used, by way of example only and not in a limiting sense, is sodium phosphate.

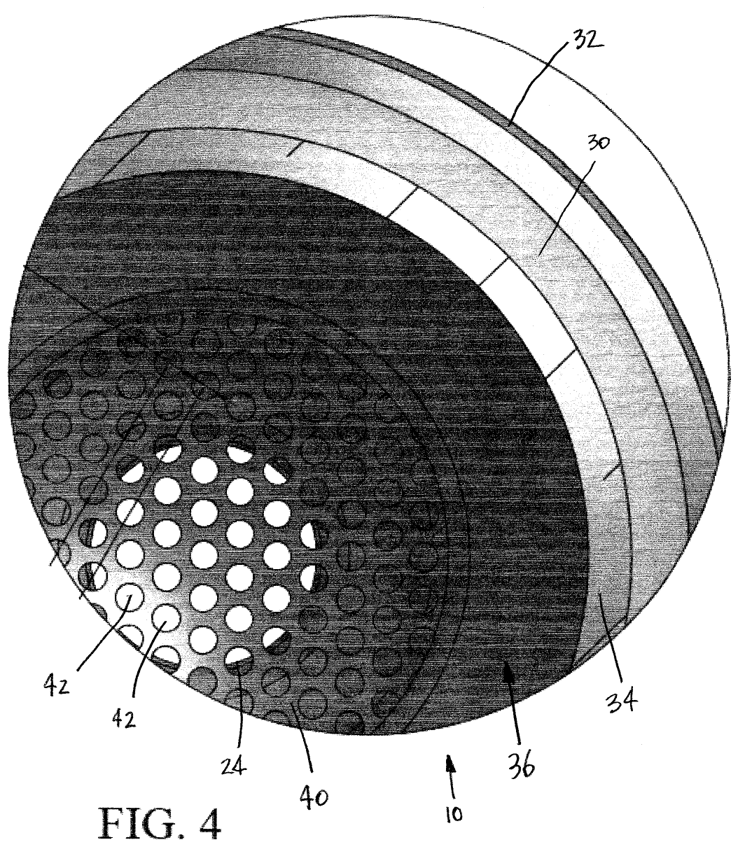

With reference now to FIG. 4, an enlarged view of the interior of the device 10 looking at the second screen 40 toward the output end 24 is shown. The device 10 is depicted having the second peripheral edge 32 surrounding the first peripheral edge 34. A portion of the second hemispherical section 30 is also visible. The second screen 40 is also shown in the lumen 36. The second screen 40 has a number of openings or holes 42 through which water and chemicals can flow. The output end 24 is also visible in this particular view.

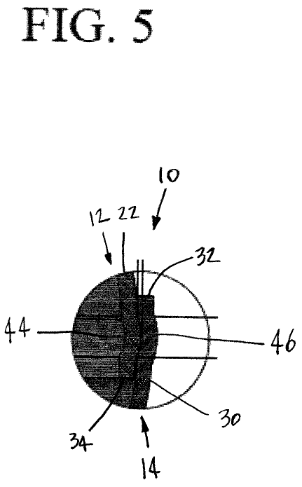

FIG. 5 illustrates the first section 12 being connected to the second section 14 of the disposable dental vacuum line cleaning device 10. The first section 12 has the peripheral edge 34 that fits within the second section 14. The first hemispherical section 22 has the peripheral edge 34 that is smaller that the second hemispherical section 30 so that the first hemispherical section 22 fits within the second hemispherical section 30. The first hemispherical section 22 has a ridge portion 44 that is adapted to snap fit into an indented portion 46 of the second hemispherical section 30. In this manner the sections 22 and 30 are in a snap fit engagement to be secured in place. It is also possible and contemplated that the sections 22 and 30 may be sealed or glued together by an adhesive or by heat welding. Although the first section 12 is shown and described as being connected to the second section 14 it is possible that the second section 14 may be constructed to fit within the first section 12. Further, although the device 10 has been described as being disposable it is also contemplated that the device 10 may be reusable in that the first section 12 and the second section 14 may be disconnected and new chemical may be placed in the hemispherical sections 22 and 30.

Once it is determined that the vacuum line needs to be cleaned, sanitized, disinfected, or deodorized of any biological or organic material left in the vacuum line after one or more dental procedures the device 10 may be used in the following manner. In operation, the device 10 has the output end 24 attached to a dental valve such as a saliva ejector or a high volume evacuator. The dental valve may be connected to a tailpiece or to vacuum line hosing or tubing. The vacuum line is connected to a source of vacuum, such as a vacuum pump, and a discharge. The device 10 is may also be connected to a water source at the input end 16. Water is allowed to flow through the device 10 to interact with any chemical positioned within the hemispherical sections 22 and 30. The chemical may flow through the device 10 out the output end 24 to sanitize and clean the vacuum line. At some point in time the chemical is flushed out of the device 10 and the water source may be turned off due to the chemical being used. Once the cleaning process is completed the device 10 may be removed and discarded or recycled. A new device 10 may be used for the next cleaning cycle. Depending upon the procedures within a dental office, the cleaning process may take place at various intervals such as hourly, daily, or weekly.

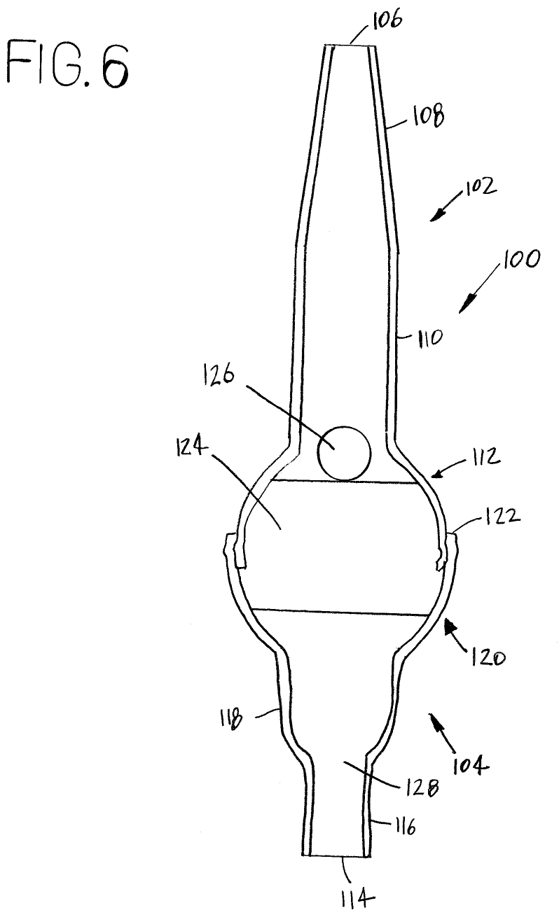

FIG. 6 shows another embodiment of a disposable dental vacuum line cleaning device 100 constructed according to the present disclosure. The device 100 comprises a first section 102 connected to a second section 104. The first section 102 has a water or fluid input end 106 that is adapted to be connected to a source of water (not shown), as will be explained in detail herein. The first section 102 has the input end 106, a tapered section 108, a straight section 110, and a first hemispherical section 112. The second section 104 has an output end 114 that is adapted to mate with a saliva ejector valve or a high volume evacuator, both of which are not shown. As can be appreciated, the valve or evacuator may be connected to a tailpiece which is connected to a vacuum line or tubing. The second section 104 has the output end 114, a straight section 116, an intermediate section 118, and a second hemispherical section 120. The second hemispherical section 120 has a peripheral edge 122 that is larger than the first hemispherical section 112 so that the first hemispherical section 112 is captured within the second hemispherical section 120. In this manner the first section 102 and the second section 104 may be secured together. A chemical, such as a tablet or pellet 124, is stored or positioned within the hemispherical sections 112 and 120. A ball 126 or stop structure may be positioned above the chemical pellet 124. A source of water may be connected to the input end 106 so that water flows through the device 100 to interact with the chemical pellet 124. The chemical pellet 124 is used to clean, sanitize, disinfect, or deodorize the vacuum hosing or tubing. Once the chemical pellet 124 dissolves or is spent the ball 126 moves to cover an opening or throat 128 of the straight section 116. In this manner the water supply is stopped and the cleaning process is complete. As indicated, although a ball 126 is shown it is possible to have some other structure that is capable of plugging the throat 128.

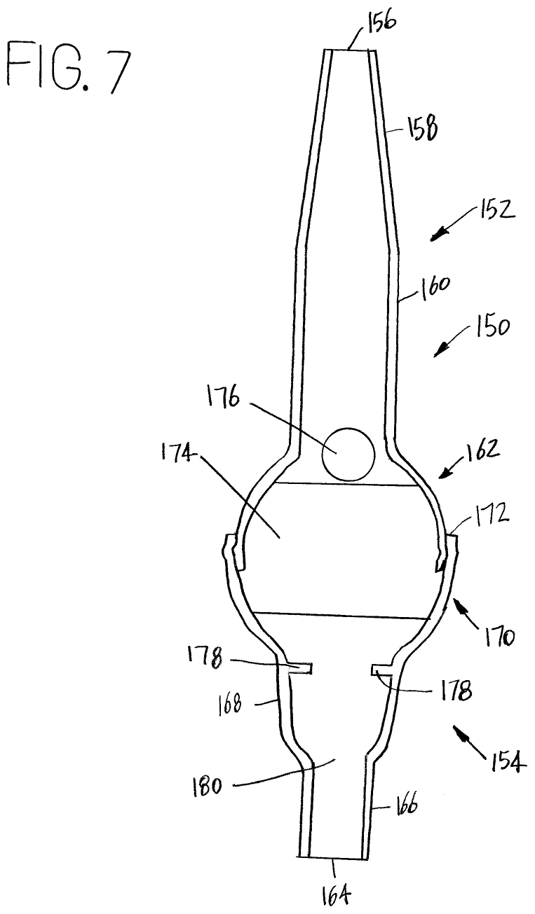

With particular reference now to FIG. 7, another embodiment of a disposable dental vacuum line cleaning device 150 is shown. The device 150 comprises a first section 152 connected to a second section 154. The first section 152 has a water or fluid input end 156 that is adapted to be connected to a source of water (not shown), as will be explained in detail herein. The first section 152 has the input end 156, a tapered section 158, a straight section 160, and a first hemispherical section 162. The second section 154 has an output end 164 that is adapted to mate with a saliva ejector valve or a high volume evacuator, both of which are not shown. As can be appreciated, the valve or evacuator may be connected to a tailpiece which is connected to a vacuum line or tubing. The second section 154 has the output end 164, a straight section 166, an intermediate section 168, and a second hemispherical section 170. The second hemispherical section 170 has a peripheral edge 172 that is larger than the first hemispherical section 162 so that the first hemispherical section 162 is captured within the second hemispherical section 170. In this manner the first section 152 and the second section 154 may be secured together. A chemical, such as a tablet or pellet 174, is stored or positioned within the hemispherical sections 162 and 170. A ball 176 or stop structure may be positioned above the chemical pellet 124. A source of water may be connected to the input end 156 so that water flows through the device 150 to interact with the chemical pellet 174. The chemical pellet 174 is used to clean, sanitize, disinfect, or deodorize the vacuum hosing or tubing. The intermediate section 168 also has an interior circular ledge 178. Once the chemical pellet 174 dissolves or is spent the ball 176 moves to cover an opening or throat 180 of the straight section 166. The circular ledge 178 is used to prevent the ball 176 from closing the throat 180 prior to the chemical pellet 174 completely dissolving. In this manner the water supply is stopped and the cleaning process is complete. Although a ball 176 is shown it is possible to have some other structure that is capable of sliding past the circular ledge 178 to plug the throat 180.

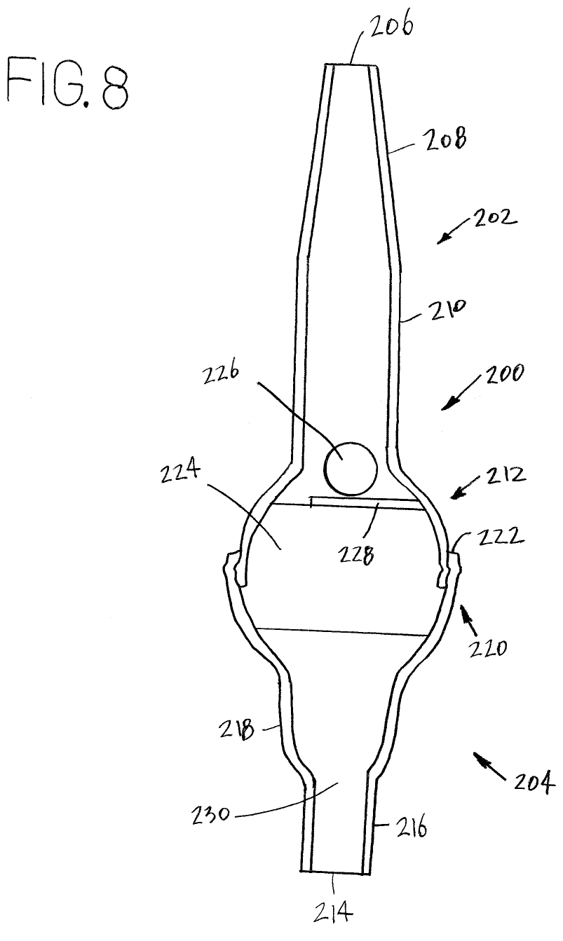

FIG. 8 depicts a cross-sectional view of another embodiment of a disposable dental vacuum line cleaning device 200 constructed according to the present disclosure. The device 200 comprises a first section 202 connected to a second section 204. The first section 202 has a water or fluid input end 206 that is adapted to be connected to a source of water (not shown). The first section 202 has the input end 206, a tapered section 208, a straight section 210, and a first hemispherical section 212. The second section 204 has an output end 214 that is adapted to mate with a saliva ejector valve or a high volume evacuator, both of which are not shown. As can be appreciated, the valve or evacuator may be connected to a tailpiece which is connected to a vacuum line or tubing. The second section 204 has the output end 214, a straight section 216, an intermediate section 218, and a second hemispherical section 220. The second hemispherical section 220 has a peripheral edge 222 that is larger than the first hemispherical section 212 so that the first hemispherical section 212 is captured within the second hemispherical section 220. In this manner the first section 202 and the second section 204 may be secured together. A chemical, such as a tablet or pellet 224, is stored or positioned within the hemispherical sections 212 and 220. A ball 226 or stop structure may be positioned above a degradable ledge 228 which is above the chemical pellet 224. A source of water may be connected to the input end 206 so that water flows through the device 200 to interact with the chemical pellet 224 and the ledge 228. The chemical pellet 224 is used to clean, sanitize, disinfect, or deodorize the vacuum hosing or tubing. It is anticipated that the chemical pellet 224 will dissolve before the ledge 228 degrades from interaction with water. Once the ledge degrades the ball 226 moves to cover an opening or throat 230 of the straight section 216. In this manner the water supply is stopped and the cleaning process is complete. As indicated, although a ball 226 is shown it is possible to have some other structure that is capable of plugging the throat 230.

The disposable dental vacuum line cleaning devices 10. 100, 150, and 200 may be formed of any suitable material such as plastic, polyethylene, and high density polyethylene or any other suitable material that is disposable and/or recyclable. Any suitable plastic may be used to construct the devices 10, 100, 150, and 200 so that the devices 10, 100, 150, and 200 may withstand use in cleaning a vacuum line after a dental operation or procedure. It is also possible and contemplated to incorporate an antimicrobial agent or chemical in the plastic or to provide a coating of an antimicrobial agent on the plastic to further prevent cross-contamination when using the devices 10, 100, 150, and 200. As can be appreciated, the antimicrobial agent may be incorporated into any of the components of the devices 10, 100, 150, and 200.

From all that has been said, it will be clear that there has thus been shown and described herein a disposable dental vacuum line cleaning device which fulfills the various advantages sought therefore. It will become apparent to those skilled in the art, however, that many changes, modifications, variations, and other uses and applications of the subject disposable dental vacuum line cleaning device are possible and contemplated. All changes, modifications, variations, and other uses and applications which do not depart from the spirit and scope of the disclosure are deemed to be covered by the disclosure, which is limited only by the claims which follow.

What is claimed is:

1. A disposable dental vacuum line cleaning device comprises:
a first section having a fluid input end that is adapted to be connected to a source of water, a tapered section, a straight section, and a first hemispherical section;
a second section having an output end that is adapted to mate with a valve, a straight section, an intermediate section, a second hemispherical section having a peripheral edge that is larger than the first hemispherical section so that the first hemispherical section is captured within the second hemispherical section; and
a chemical positioned within the first section and the second section.

2. The disposable dental vacuum line cleaning device of claim 1 wherein the first section may be sealed to the second section.

3. The disposable dental vacuum line cleaning device of claim 1 wherein the device is constructed of plastic.

4. The disposable dental vacuum line cleaning device of claim 1 wherein the device incorporates an antimicrobial agent.

5. The disposable dental vacuum line cleaning device of claim 1 further comprising a lumen between the input end and the output end.

6. The disposable dental vacuum line cleaning device of claim 1 wherein the chemical is a tablet.

7. The disposable dental vacuum line cleaning device of claim 1 wherein the chemical is a pellet.

8. A disposable dental vacuum line cleaning device comprises:
a first section having a fluid input end that is adapted to be connected to a source of water, a tapered section, a straight section, a first hemispherical section, and a first screen formed in the straight section;
a second section having an output end that is adapted to mate with a valve, a straight section, an intermediate section, a second hemispherical section having a peripheral edge that is larger than the first hemispherical section so that the first hemispherical section is captured within the second hemispherical section, and a second screen formed in the intermediate section; and
a chemical positioned within the first section and the second section.

9. The disposable dental vacuum line cleaning device of claim 8 wherein the aerosol directing device is constructed of plastic.

10. The disposable dental vacuum line cleaning device of claim 8 wherein the first screen comprises openings.

11. The disposable dental vacuum line cleaning device of claim 8 wherein the second screen comprises openings.

12. The disposable dental vacuum line cleaning device of claim 8 wherein the first screen bulges into the straight section of the first section.

13. The disposable dental vacuum line cleaning device of claim 8 wherein the second screen bulges into the intermediate section of the second section.

14. The disposable dental vacuum line cleaning device of claim 8 wherein the first section is sealed to the second section.

15. A disposable dental vacuum line cleaning device comprises:
a first section having a fluid input end that is adapted to be connected to a source of water, a funnel section, a straight section, a first hemispherical section having a first peripheral edge;
a second section having an output end that is adapted to mate with a valve, a straight section, an intermediate section, a second hemispherical section having a second peripheral edge that is larger than the first peripheral edge so that the first hemispherical section is captured within the second hemispherical section;
a lumen formed within the first section and the second section between the input end and the output end; and
a chemical positioned within the lumen.

16. The disposable dental vacuum line cleaning device of claim 15 wherein the first section may be sealed to the second section.

17. The disposable dental vacuum line cleaning device of claim 15 wherein the device is constructed of plastic.

18. The disposable dental vacuum line cleaning device of claim 15 wherein the chemical is a tablet.

19. The disposable dental vacuum line cleaning device of claim 15 wherein the chemical is a pellet.

20. The disposable dental vacuum line cleaning device of claim 15 wherein the first hemispherical section has a ridge portion and the second hemispherical section has an indented portion and the ridge portion fits within the indented portion to connect the first section to the second section.
